(19) United States
(12) Patent Application Publication
(10) Pub. No.: US 2012/0181877 A1
(43) Pub. Date: Jul. 19, 2012

(54) Configuration and method for activating at least one triggering element for a passenger protection means

(76) Inventor: Alain Jousse, Stuttgart (DE)

(21) Appl. No.: 13/383,738

(22) PCT Filed: May 26, 2010
(86) PCT No.: PCT/EP2010/057202

§ 371 Date: Apr. 2, 2012

(30) Foreign Application Priority Data
Jul. 22, 2009 (DE) 10 2009 027 918.0

(51) Int. Cl. B60R 21/017

(52) U.S. Cl. 307/113

(57) ABSTRACT

A circuit configuration for activating a triggering element for a passenger protection arrangement includes a high-side circuit which establishes a first connection between an energy source and the triggering element, and a low-side circuit which establishes a second connection between the triggering element and ground. In addition, a regulator, which regulates a triggering current for the triggering element is provided, the regulator being assigned to the high-side circuit and/or the low-side circuit, and the high-side circuit and/or the low-side circuit each have/has two output stages, which are connected in parallel, for regulating the triggering current per triggering element, at least one of the at least two output stages having a current regulator at least one transistor connected in parallel.

### BACKGROUND OF THE INVENTION

1. Field of the Invention

The present invention relates to a configuration and a method for activating at least one triggering element for a passenger protection means.

2. Description of Related Art

Published German patent application document DE 10 2004 010 135 A1 describes a device for supplying electrical current to at least one ignition output stage with the aid of an ignition current from an energy reserve. A voltage regulator, which adjusts a voltage on the at least one ignition output stage to a predefined value, is provided between the energy reserve and the at least one ignition output stage.

### BRIEF SUMMARY OF THE INVENTION

The configuration according to the present invention and the method according to the present invention for activating at least one triggering element for a passenger protection means have the advantage over the related art that a scaling is provided by output stages connected in parallel to one another, at least one of the output stages having a current regulator and one or more output stages connected in parallel. This avoids the disadvantages that oversized transistors are provided in situations of low ignition current requirements and a discrete approach is provided when there is a high ignition current requirement. The parallelization of the output stages makes a scaling possible, i.e., higher and longer triggering current pulses are implemented using two or more output stages connected in parallel. Therefore smaller output stages may also be used. This yields a simplification and a cost reduction for the configuration.

The term configuration in the present case is understood to refer to the control unit or the part of the circuit of the control unit which causes the activation of the at least one triggering element for a passenger protection means.

Activating in the present case refers to the activation of the triggering element for the passenger protection means. This means that the activation causes electric current to flow through the triggering element and thus ignites a firing charge, or in the electromagnetic case, it causes magnetic activation of a passenger protection means.

The triggering element is, for example, an ignition element, which is ultimately a firing charge to pyrotechnically activate an airbag or a seatbelt tightener, for example. In the case of an electromagnetic actuator system, the triggering element refers to a coil, for example, which generates through the current flow a magnetic field which induces the activation of a passenger protection means.

A passenger protection means is understood to refer to passenger protection means such as airbags, seatbelt tighteners, crash-active headrests as well as pedestrian protection means, etc.

The high-side circuit refers to the circuit which is situated between the triggering element and the energy source and which ultimately establishes the connection between the energy source and the triggering element. Since the high-side circuit is not only ultimately a switch but also regulates the current flowing from the energy source to the triggering element, a current regulator is provided with the high-side circuit and/or with the low-side circuit, establishing the second connection from the triggering element to ground. The energy source in the present case is understood to refer to an energy reserve having one or multiple capacitors, for example, and the connection means only that a current may flow in the present case.

Ground in the present case is understood to be ground in the control unit, which is identical to ground on the chassis.

The regulator of the triggering current may be situated either in the high-side circuit or in the low-side circuit or even in both circuits. The regulator causes the triggering current to be adjusted to a certain shape. This may refer only to one current value having one amplitude, but also the duration of a triggering current pulse. Shaping of the pulse per se is also possible. A preferred specific embodiment of the current regulator compares an ignition current, which will be flowing through the output stage and is measured via a shunt, with a reference current. The output stage is activated as a function of this comparison, i.e., the base or the gate of the output stage transistor. This control current is superimposed on the activation signal, which activates the output stage transistor when an activation case has been detected.

Output stages connected in parallel are understood to be circuits connected in parallel, at least one of the output stages having a current regulator and one or multiple transistors connected in parallel. If preferably only one current regulator is provided, then this one current regulator also regulates the current of the transistor(s) of the other output stage. Furthermore, it is also possible for the output stage to have a plurality of transistors connected in parallel which are activated by the current regulator.

This parallel circuit of at least two output stages is provided for each triggering element, so that when electrical current is supplied to one triggering element, these output stages connected in parallel ensure the shaping of the triggering current. As already indicated above, the parallel circuit of the at least two output stages may be situated either in the high-side circuit or in the low-side circuit or in both circuits.

In contrast with the related art, now at least two output stages, having at least two transistors, are used per triggering element; this represents a cost factor per se but it may cover a greater bandwidth of requirements of the triggering current. Therefore a larger number of ASICs, for example, may be manufactured using the configuration according to the present invention and this in turn achieves a cost advantage.

The partial ignition currents which flow through the output stages connected in parallel are preferably of the same size to distribute the thermal load uniformly, for example, and to be able to connect the same transistors in parallel in particular, which offers considerable cost advantages.

A particular output stage advantageously has a particular current regulator assigned only to this output stage. Thus in the simplest case, the two output stages are each provided with one current regulator. This makes it possible for each output stage, i.e., each transistor, for example, a MOSFET or some other power transistor, to have an individual current regulator.

Advantageously only one single output stage has a single current regulator assigned just to it, but this current regulator activates at least one additional output stage for regulating the triggering current. This means that the current regulator transmits an activation signal to a first output stage and also to a second output stage, the second output stage not having its own current regulator in this case.

It is also advantageous that the single current regulator measures all the partial triggering currents flowing to the particular output stages and activates the transistors of the output stages as a function of these measurements. This may result in each transistor receiving the same signal from this current regulator or also an individual signal. This would then be a multichannel current regulator. As stated above, this measurement is usually performed using a shunt resistor.

In addition, it is advantageous that the output stages connected in parallel are situated on an integrated circuit and that the partial ignition currents are combined outside of the integrated circuit. This utilizes the advantages of an integrated circuit, but the high current level which results due to the addition of the partial triggering currents is generated only outside of this ASIC (=application-specific integrated circuit) by superimposition or addition of the currents. This avoids that for the integrated circuit, typically an ASIC, expensive measures for this high triggering current may be avoided. This also makes the embodiment of the configuration according to the present invention less expensive. A corresponding output pin is assigned to each output stage on the ASIC, so that there is great flexibility with regard to the use of the output stages.

The high-side circuit and the low-side circuit may advantageously be situated on the integrated circuit.

The triggering current is advantageously regulated in such a way that at least one triggering current pulse having a duration and amplitude set by the regulator is generated for the at least one triggering element. This describes the fact that through the regulation, which involves multiple transistors in particular, a complex triggering current pulse is generated by superimposition. The activation is performed, for example, in a control unit for activating passenger protection means, by a microcontroller in the control unit via the so-called SPI (serial peripheral interface) line, i.e., a serial interface to the ASIC, which includes the ignition circuit according to the present invention. For this purpose, the ASIC has a processing logic, which causes a predetermined ignition pulse to be generated by the output stages, either in that a corresponding activation signal is superimposed on the current regulator or in that the current regulator causes this ignition pulse.

### BRIEF DESCRIPTION OF THE DRAWINGS

FIG. 1 shows a block diagram of a control unit for activating passenger protection means having the configuration according to the present invention.

FIG. 2 shows a first exemplary embodiment of the configuration according to the present invention.

FIG. 3 shows a second exemplary embodiment of the configuration according to the present invention.

FIG. 4 shows a third exemplary embodiment of the configuration according to the present invention.

FIG. 5 shows typical triggering current pulses.

FIG. 6 shows a flow chart of the method according to the present invention.

FIG. 7 shows a wiring diagram of the regulator according to the present invention.

### DETAILED DESCRIPTION OF THE INVENTION

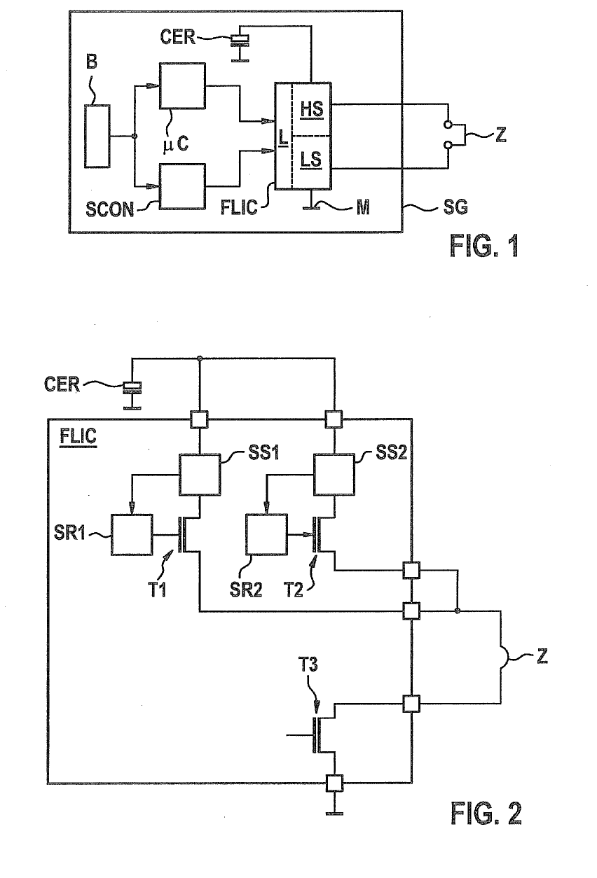

FIG. 1 shows a control unit SG having the configuration according to the present invention in a block diagram. The configuration according to the present invention includes essentially the integrated circuit FLIC having the output stage. However, control unit SG initially has an acceleration sensor B, whose signal is input, on the one hand, into a microcontroller μC and, on the other hand, into a security controller SCON. The acceleration signals are thus evaluated independently of each other, and the results of the evaluation, i.e., the activation signals, go over the SPI line and/or other lines to output stage circuit FLIC and go there into a logic part L.

The activation signals of microcontroller μC and of security controller SCON are linked as a function of a logic linkage, for example, a logic AND linkage. The purpose of the linkage is for the output stage circuit to recognize that triggering element Z is to be activated. High-side circuit HS then connects triggering element Z to energy reserve CER, having a capacitor, which has been charged by the battery voltage to a higher voltage. Low-side circuit LS on integrated circuit FLIC connects triggering element Z to ground M, which is the ground of the control unit or the chassis. High-side circuit HS and low-side circuit LS may have one or multiple transistors as power switches. These transistors and the corresponding current regulator form the output stages according to the present invention, at least two of each being connected in parallel.

FIG. 2 shows a first exemplary embodiment in the configuration according to the present invention. The goal is to shape the ignition current to a predefined shape as the triggering current pulse. The ignition current comes from energy reserve CER as soon as transistors T1 and T2 are opened. The current from energy reserve CER is divided into a first path to current measuring site SS1 and a second path to current measuring site SS2. These current measuring sites SS1 and SS2 supply the measured value for current regulators SR1 and SR2. The current measuring sites are usually designed as shunt resistors.

The current then continues to flow to transistors T1 and T2, which are designed here as transistors having power switches, but which have a variable volume resistance and are activated accordingly. Current regulators SR1 and SR2 regulate this volume resistance of transistors T1 and T2 accordingly. The pulse shape described above is also possible. The partial triggering currents regulated in this way flow from transistors T1 and T2 to interfaces of integrated circuit FLIC and are additively superimposed outside of integrated circuit FLIC. This additively superimposed triggering current flows to ignition element Z. The current flowing through the ignition element is picked up by the low-side circuit, which includes only one transistor T3, and is dissipated to ground. To do so transistor T3 is activated accordingly. It is possible that instead of transistors T1, T2 and T3, a parallel circuit of a plurality of transistors is present.

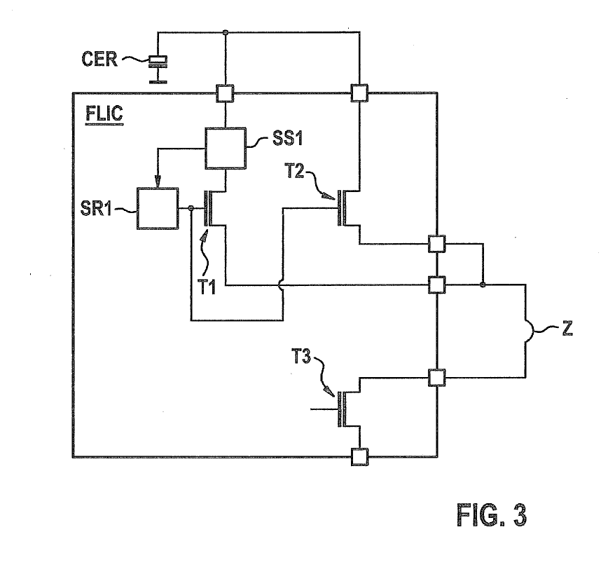

FIG. 3 shows a second exemplary embodiment of the configuration according to the present invention, in which the same elements are labeled with the same reference numerals. Again the triggering current goes from energy reserve CER to the two paths having transistors T1 and T2. However, the first path still has current measurement SS1, which is forwarded to current regulator SR1, but current regulator SR1 activates not only transistor T1 as before but also activates transistor T2. The implementation of the current regulator and the corresponding measurement points may thus be reduced. This may also be done for a plurality of additional transistors without current regulators.

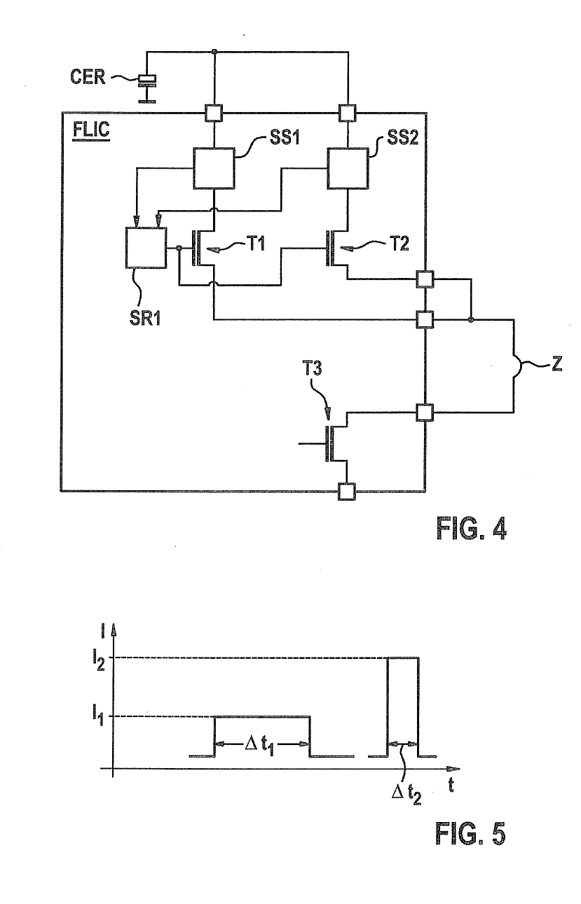

FIG. 4 shows a third exemplary embodiment of the device according to the present invention. In contrast with the previous figure, it is now provided that current regulator SR1 measures not only current SS1 but also current SS2. Transistors T1 and T2 are in turn activated by current regulator SR1, but now on the basis of two measurements, namely those of SS1 and SS2. Transistor T3 is again connected through only when a triggering case has been detected.

In a current-time diagram, FIG. 5 illustrates various examples, which may be achieved through the circuit according to the present invention. First a wide pulse having ΔT1 and amplitude I1 is shown. However, pulses having amplitude I2 and pulse width ΔT2 are also possible.

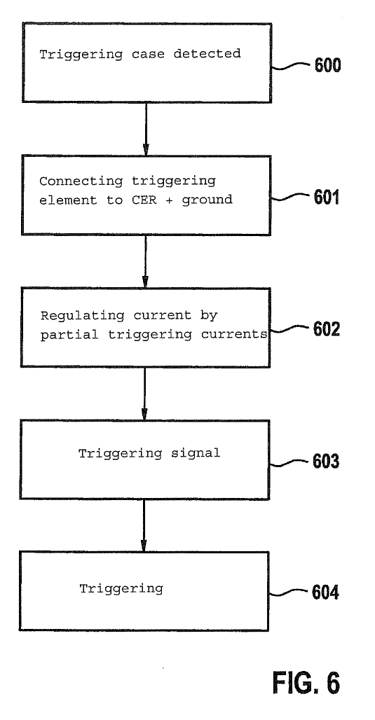

FIG. 6 illustrates in a flow chart the method according to the present invention. In method step 600, a triggering case is detected by the crash sensor system, in that the crash signal is evaluated by microcontroller μC and security controller SCON independently of one another. These two partial results are combined in output stage circuit FLIC by a logic unit, for example a logic AND.

In method step 601, triggering element Z is connected to the energy reserve and to ground via the high-side circuit and the low-side circuit. In method step 602, the triggering current is regulated by the use of partial triggering currents, as already indicated above. In method step 603, the deployment signal is output by superimposition of the partial triggering currents. In method step 604, the triggering element and thus the passenger protection means are then ultimately triggered.

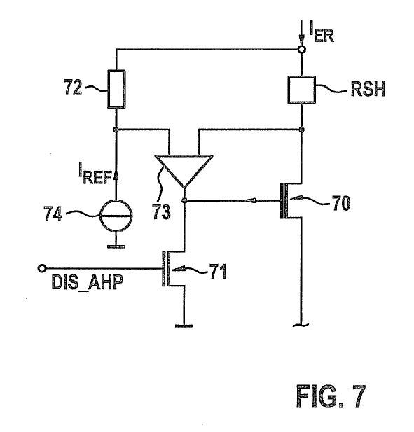

FIG. 7 shows an embodiment of a current regulator, which may be implemented in the high-side circuit and/or low-side circuit. Current IER comes from energy reserve CER, is measured via shunt resistor RSH, and goes to a first input of a comparator 73. A reference current IREF from a reference current source 74 is input into the second input. Resistor 72 is of such a dimension that the intended function is achieved. The output of the comparator leads to the gate of transistor 70 and to the source of a transistor 71 which activates transistor 70 and is itself activated by signal DIS_AHP via the aforementioned logic unit. This means that the regulated current flows through transistor 71 to ground and results in a voltage at the gate of transistor 70.

1-10. (canceled)

11. A circuit configuration for activating at least one triggering element for a passenger protection arrangement, comprising:
a high-side circuit, which establishes a first connection from an energy source to the at least one triggering element; and
a low-side circuit, which establishes a second connection from the at least one triggering element to ground;
wherein at least one of the high-side circuit and the low-side circuit has at least two output stages connected in parallel for regulating a triggering current for the triggering element, and wherein at least one of the at least two output stages connected in parallel has a first current regulator and at least one transistor connected in parallel.

12. The configuration as recited in claim 11, wherein each of the at least two output stages has only a single second current regulator.

13. The configuration as recited in claim 11, wherein only one of the at least two output stages has only a single second current regulator which activates the other one of the least two output stages for regulating the triggering current.

14. The configuration as recited in claim 13, wherein the single second current regulator (i) measures all partial triggering currents flowing to the at least two output stages, and (ii) activates the other one of the least two output stages as a function of these measurements.

15. The configuration as recited in claim 14, wherein the at least two output stages connected in parallel are situated on a single integrated circuit and the partial triggering currents are combined outside of the integrated circuit.

16. The configuration as recited in claim 15, wherein the high-side circuit and the low-side circuit are situated on the single integrated circuit.

17. The configuration as recited in claim 11, wherein the triggering current is regulated in such a way that at least one triggering current pulse having a duration and amplitude set by the first current regulator is generated for the triggering element.

18. A method for activating at least one triggering element for a passenger protection arrangement, comprising:
establishing a first connection of the at least one triggering element to an energy source by a high-side circuit;
establishing a second connection of the at least one triggering element to ground by a low-side circuit;
regulating a triggering current for the triggering element by at least one parallel circuit of least two output stages connected in parallel, wherein the at least one parallel circuit is assigned to one of the high-side circuit or the low-side circuit, and wherein at least one of the at least two output stages has a first current regulator and at least one transistor connected in parallel.

19. The method as recited in claim 18, wherein only one of the at least two output stages has only a single second current regulator which activates the other one of the least two output stages for regulating the triggering current.

20. The method as recited in claim 18, wherein the triggering current is regulated in such a way that at least one triggering current pulse having a duration and amplitude set by the first current regulator is generated for the triggering element.
